(19) United States
(12) Patent Application Publication
(10) Pub. No.: US 2018/0092063 A1
(43) Pub. Date: Mar. 29, 2018

(54) UPLINK AND DOWNLINK BASED MOBILITY WITH SINGLE FREQUENCY NETWORK PAGING AND/OR KEEP ALIVE SIGNALS

(71) Applicant: QUALCOMM Incorporated, San Diego, CA (US)

(72) Inventors: Kambiz AZARIAN YAZDI, San Diego, CA (US); Haitong SUN, Sunnyvale, CA (US); Tingfang JI, San Diego, CA (US); Hung LY, San Diego, CA (US)

(21) Appl. No.: 15/709,042

(22) Filed: Sep. 19, 2017

Related U.S. Application Data
(60) Provisional application No. 62/401,788, filed on Sep. 29, 2016.

(51) Int. Cl. H04W 68/10

(52) U.S. Cl. CPC H04W 68/10; H04W 76/048

(57) ABSTRACT

Certain aspects of the present disclosure provide techniques for uplink and downlink based mobility using single frequency network (SFN) paging and/or keep alive (KA) signals in a wireless network, such as new radio (NR). According to certain aspects, a method of wireless communication by a user equipment (UE) is provided. The method generally includes receiving a paging message, wherein the paging message comprises a SFN transmission from a plurality of cells that transmit an identical paging message simultaneously on a same frequency and decoding the paging message. Another method performed by a UE is provided, including transmitting an uplink reference signal to one or more of a plurality of cells, receiving a KA signal from at least two of the plurality of cells, and monitoring for a paging message based on the KA signal.

### CROSS-REFERENCE TO RELATED APPLICATION & PRIORITY CLAIM

This application claims benefit of and priority to U.S. Provisional Patent Application Ser. No. 62/401,788, filed Sep. 29, 2016, which is herein incorporated by reference in its entirety for all applicable purposes.

### INTRODUCTION

Aspects of the present disclosure relate generally to wireless communications systems, and more particularly, to uplink and downlink based mobility with single frequency network (SFN) paging and/or keep alive (KA) signals in a wireless network, such as a new radio (NR) technology network.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include 3rd Generation Partnership Project (3GPP) Long Term Evolution (LTE) systems, LTE-Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

In some examples, a wireless multiple-access communication system may include a number of base stations (BSs) that each can support communication for multiple communication devices, otherwise known as user equipment (UEs). In LTE or LTE-A network, a set of one or more base stations may define an e NodeB (eNB). In other examples, such as new radio (NR) (e.g., next generation or 5G networks), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more distributed units, in communication with a central unit, may define an access node (e.g., a new radio base station (NR BS), a new radio node-B (NR NB), a network node, 5G NB, Next Generation Node B (gNB), etc.). A BS or DU may communicate with a set of UEs on downlink channels (e.g., for transmissions from a BS or to a UE) and uplink channels (e.g., for transmissions from a UE to BS or DU).

These multiple access technologies have been adopted in various telecommunication standards to provide a common protocol that enables different wireless devices to communicate on a municipal, national, regional, and even global level. An example of an emerging telecommunication standard is new radio (NR), for example, 5G radio access. NR is a set of enhancements to the LTE mobile standard promulgated by Third Generation Partnership Project (3GPP). It is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL) as well as support beamforming, multiple-input multiple-output (MIMO) antenna technology, and carrier aggregation.

However, as the demand for mobile broadband access continues to increase, there exists a need for further improvements in NR technology. Preferably, these improvements should be applicable to other multi-access technologies and the telecommunication standards that employ these technologies.

### BRIEF SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

Certain aspects of the present disclosure generally relate to methods and apparatus for uplink and downlink based mobility using single frequency network (SFN) paging and/or keep alive (KA) signals in a wireless network, such as new radio (NR) (e.g., a 5G network).

Certain aspects of the present disclosure provide a method for wireless communication that may be performed, for example, by a user equipment (UE). The method generally includes receiving a paging message. The paging message is a SFN transmission. The UE decodes the paging message.

Certain aspects of the present disclosure provide another method for wireless communication that may be performed, for example, by a UE. The method generally includes transmitting an uplink reference signal to one or more of a plurality of cells. The UE receives a KA signal from at least two of the plurality of cells and monitors for a paging message based on the KA signal.

Certain aspects of the present disclosure provide a method for wireless communication that may be performed, for example, by a base station (BS). The method generally includes determining to send a paging message to a UE. In response to the determination, the BS sends a paging message to the UE. The paging message is a SFN transmission.

Certain aspects of the present disclosure provide another method for wireless communication that may be performed, for example, by a BS. The method generally includes determining to send a KA signal to a UE and sending the KA to the UE. The KA signal is sent as a SFN transmission.

Certain aspects of the present disclosure provide a method for wireless communication that may be performed, for example, by a network entity. The method generally includes configuring a first cell to transmit a KA signal to a UE and configuring at least a second cell to transmit a KA signal to the UE.

Certain aspects of the present disclosure provide an apparatus for wireless communication such as, for example, a UE. The apparatus generally includes means for receiving a paging message. The paging message is a SFN transmission. The apparatus includes means for decoding the paging message.

Certain aspects of the present disclosure provide another apparatus for wireless communication such as, for example, a UE. The apparatus generally includes means for transmitting an uplink reference signal to one or more of a plurality of cells. The apparatus includes means for receiving a KA signal from at least two of the plurality of cells and means for monitoring for a paging message based on the KA signal.

Certain aspects of the present disclosure provide an apparatus for wireless communication such as, for example, a BS. The apparatus generally includes means for determining to send a paging message to a UE. The apparatus includes means for sending a paging message to the UE in response to the determination. The paging message is a SFN transmission.

Certain aspects of the present disclosure provide another apparatus for wireless communication such as, for example, a BS. The apparatus generally includes means for determining to send a KA signal to a UE. The apparatus includes means for sending the KA to the UE. The KA signal is sent as a SFN transmission.

Certain aspects of the present disclosure provide an apparatus for wireless communication such as, for example, a network entity. The apparatus generally includes means for configuring a first cell to transmit a KA signal to a UE and means for configuring at least a second cell to transmit a KA signal to the UE.

Certain aspects of the present disclosure provide an apparatus for wireless communication such as, for example, a UE. The apparatus generally includes a receiver configured to receive a paging message. The paging message comprises a SFN transmission. The apparatus includes at least one processor coupled with a memory and configured to decode the paging message.

Certain aspects of the present disclosure provide another apparatus for wireless communication such as, for example, a UE. The apparatus generally includes a transmitter configured to transmit an uplink reference signal to one or more of a plurality of cells. The apparatus includes a receiver configured to receive a KA signal from at least two of the plurality of cells. The apparatus includes at least one processor coupled with a memory and configured to monitor for a paging message based on the KA signal.

Certain aspects of the present disclosure provide an apparatus for wireless communication such as, for example, a BS. The apparatus generally includes at least one processor coupled with a memory and configured to determine to send a paging message to a UE. The apparatus includes a transmitter configured to send a paging message to the UE in response to the determination. The paging message comprises a SFN transmission.

Certain aspects of the present disclosure provide another apparatus for wireless communication such as, for example, a BS. The apparatus generally includes at least one processor coupled with a memory and configured to determine to send a KA signal to a UE. The apparatus includes a transmitter configured to send the KA to the UE. The KA signal is sent as a SFN transmission.

Certain aspects of the present disclosure provide an apparatus for wireless communication such as, for example, a network entity. The apparatus generally includes at least one processor coupled with a memory and configured to configure a first cell to transmit a KA signal to a UE and configure at least a second cell to transmit a KA signal to the UE.

Certain aspects of the present disclosure provide a computer readable medium having computer executable code stored thereon for wireless communication such as, for example, a UE. The computer readable medium generally includes code for receiving a paging message. The paging message is a SFN transmission. The computer readable medium includes code for decoding the paging message.

Certain aspects of the present disclosure provide a computer readable medium having computer executable code stored thereon for wireless communication such as, for example, a UE. The computer readable medium generally includes code for transmitting an uplink reference signal to one or more of a plurality of cells, code for receiving a KA signal from at least two of the plurality of cells, and code for monitoring for a paging message based on the KA signal.

Certain aspects of the present disclosure provide a computer readable medium having computer executable code stored thereon for wireless communication such as, or example, a BS. The computer readable medium generally includes code for determining to send a paging message to a UE and code for sending a paging message to the UE in response to the determination. The paging message comprises a SFN transmission.

Certain aspects of the present disclosure provide a computer readable medium having computer executable code stored thereon for wireless communication such as, for example, a BS. The computer readable medium generally includes code for determining to send a KA signal to a UE and code for sending the KA to the UE. The KA signal is sent as a SFN transmission.

Certain aspects of the present disclosure provide a computer readable medium having computer executable code stored thereon for wireless communication such as, for example, a network entity. The computer readable medium generally includes code for configuring a first cell to transmit a KA signal to a UE and code for configuring at least a second cell to transmit a KA signal to the UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram illustrating an example logical architecture of a distributed radio access network (RAN), in accordance with certain aspects of the present disclosure.

FIG. 3 is a diagram illustrating an example physical architecture of a distributed RAN, in accordance with certain aspects of the present disclosure.

FIG. 4 is a block diagram conceptually illustrating a design of an example base station (BS) and user equipment (UE), in accordance with certain aspects of the present disclosure.

FIG. 5 is a diagram showing examples for implementing a communication protocol stack, in accordance with certain aspects of the present disclosure.

FIG. 6 illustrates an example of a downlink-centric slot, in accordance with certain aspects of the present disclosure.

FIG. 7 illustrates an example of an uplink-centric slot, in accordance with certain aspects of the present disclosure.

FIG. 8 illustrates an example of a wireless communication system supporting zones, in accordance with certain aspects of the present disclosure.

FIG. 9 is a transmission time illustrating an example downlink-based mobility scenario, in accordance with certain aspects of the present disclosure.

FIG. 10 is a transmission time illustrating an example uplink-based mobility scenario, in accordance with certain aspects of the present disclosure.

FIG. 11 is a flow diagram illustrating example operations that may be performed by a UE for receiving a paging message as a single frequency network (SFN) transmission, in accordance with certain aspects of the present disclosure.

FIG. 12 is a flow diagram illustrating example operations that may be performed by a BS for sending a paging message as a SFN transmission, in accordance with certain aspects of the present disclosure.

FIG. 13 is a call flow diagram illustrating example signaling of paging messages as SFN transmissions for downlink-based mobility, in accordance with certain aspects of the present disclosure.

FIG. 14 is a flow diagram illustrating example operations that may be performed by a UE for receiving a keep alive (KA) signal from multiple BSs, in accordance with certain aspects of the present disclosure.

FIG. 15 is a flow diagram illustrating example operations that may be performed by a BS for sending a KA signal as a SFN transmission, in accordance with certain aspects of the present disclosure.

FIG. 16 is a call flow diagram illustrating example signaling of paging messages and/or KA signals as SFN transmissions for uplink-based mobility, in accordance with certain aspects of the present disclosure.

FIG. 17 is a flow diagram illustrating example operations that may be performed by a network for configuring multiple cells to transmit KA signals to the UE, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for new radio (NR) (new radio access technology or 5G technology). NR may support various wireless communication services, such as Enhanced mobile broadband (eMBB) targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra reliable low latency communications (URLLC). These services may include latency and reliability requirements. These services may also have different transmission time intervals (TTI) to meet respective quality of service (QoS) requirements. In addition, these services may co-exist in the same subframe.

In downlink-based mobility, the network (e.g., base station (BS)) sends a reference signals (e.g., a measurement reference signal (MRS)) and the UE performs cells search based on the RSs. In uplink-based mobility, the UE sends uplink reference signals (e.g., chirps) and the network performs cell search based on the URSs.

In the downlink-based mobility, the UE may receive monitor for paging messages sent from the selected cell during paging occasions. Since the network may be aware of a tracking area (TA) to which the UE is registered, but not aware of the selected cell, paging may be paged by all of the cells in the TA; however, each cell transmits its paging channel independently of the other cells. Thus, the paging messages may interfere with one another. In the uplink-based mobility, the may monitor for a keep alive (KA) signal after sending the URS. The KA signal may indicate paging for the UE. In some cases, the best cell may not be selected. In this case, the KA signal and/or paging may be missed.

Aspects of the present disclosure provide techniques and apparatus for uplink and downlink based mobility using single frequency network (SFN) paging message and/or KA signal transmissions in a wireless network, such as NR.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication networks such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). NR is an emerging wireless communications technology under development in conjunction with the 5G Technology Forum (5GTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

### Example Wireless Communications System

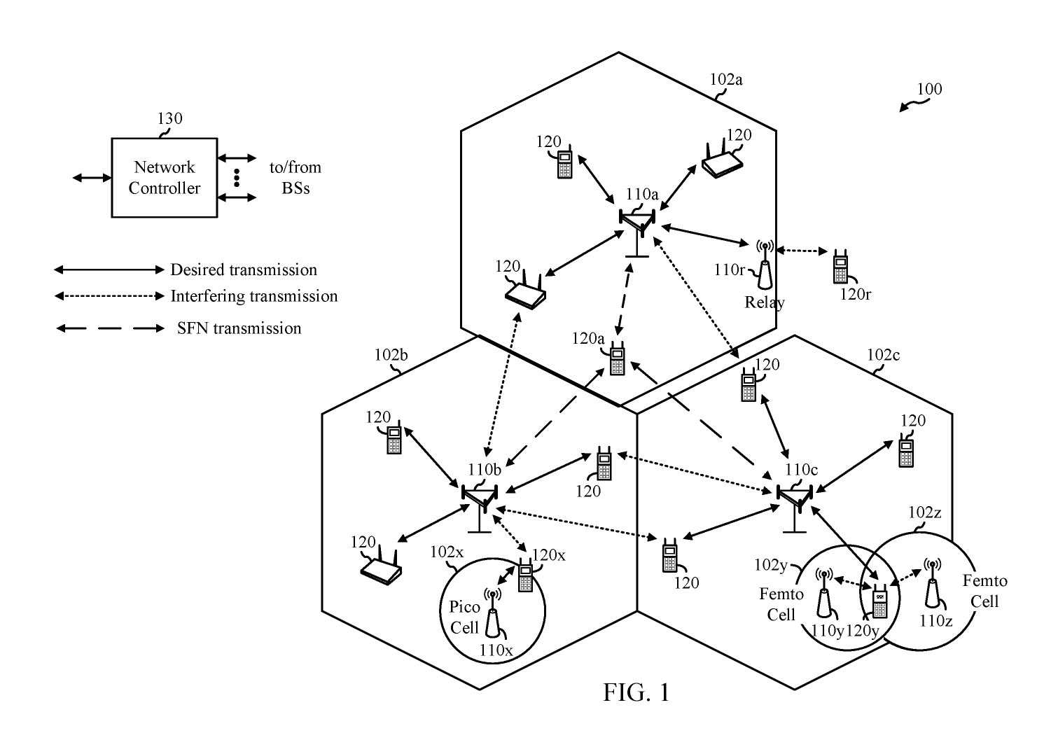

FIG. 1 illustrates an example wireless network 100 in which aspects of the present disclosure may be performed. For example, the wireless network may be a new radio (NR) or 5G network. For example, UE 120a may receive single frequency network (SFN) transmissions from the base stations (BSs) 110a, 110b, and 110c. The SFN transmissions may be identical paging messages and/or keep alive (KA) signals that are transmitted simultaneously on a same frequency. The BSs 110a, 110b, and 110c may be transmission reception points (TRPs), Node Bs (NBs), 5G NBs, access points (APs), new radio (NR) BSs, Next Generation Node Bs (gNBs), etc.). The BSs 110a, 110b, and 110c may be in same tracking area (TA) or zone.

As illustrated in FIG. 1, the wireless network 100 may include a number of BSs 110 and other network entities. A BS may be a station that communicates with UEs. Each BS 110 may provide communication coverage for a particular geographic area. In 3GPP, the term “cell” can refer to a coverage area of a Node B and/or a Node B subsystem serving this coverage area, depending on the context in which the term is used. In NR systems, the term “cell” and gNB, Node B, 5G NB, AP, NR BS, NR BS, or TRP may be interchangeable. In some examples, a cell may not necessarily be stationary, and the geographic area of the cell may move according to the location of a mobile BS. In some examples, the BSs may be interconnected to one another and/or to one or more other BSs or network nodes (not shown) in the wireless network 100 through various types of backhaul interfaces such as a direct physical connection, a virtual network, or the like using any suitable transport network.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a frequency channel, etc. Each frequency may support a single RAT in a given geographic area in order to avoid interference between wireless networks of different RATs. In some cases, NR or 5G RAT networks may be deployed.

A BS may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BS for the femto cells 102y and 102z, respectively. A BS may support one or multiple (e.g., three) cells.

The wireless network 100 may also include relay stations. A relay station is a station that receives a transmission of data and/or other information from an upstream station (e.g., a BS or a UE) and sends a transmission of the data and/or other information to a downstream station (e.g., a UE or a BS). A relay station may also be a UE that relays transmissions for other UEs. In the example shown in FIG. 1, a relay station 110r may communicate with the BS 110a and a UE 120r in order to facilitate communication between the BS 110a and the UE 120r. A relay station may also be referred to as a relay BS, a relay, etc.

The wireless network 100 may be a heterogeneous network that includes BSs of different types, e.g., macro BS, pico BS, femto BS, relays, etc. These different types of BSs may have different transmit power levels, different coverage areas, and different impact on interference in the wireless network 100. For example, a macro BS may have a high transmit power level (e.g., 20 Watts) whereas pico BS, femto BS, and relays may have a lower transmit power level (e.g., 1 Watt).

The wireless network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time. The techniques described herein may be used for both synchronous and asynchronous operation.

A network controller 130 may couple to a set of BSs and provide coordination and control for these BSs. The network controller 130 may communicate with the BSs 110 via a backhaul. The BSs 110 may also communicate with one another, e.g., directly or indirectly via wireless or wireline backhaul.

The UEs 120 (e.g., 120x, 120y, etc.) may be dispersed throughout the wireless network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered evolved or machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices.

In FIG. 1, a solid line with double arrows indicates desired transmissions between a UE and a serving BS, which is a BS designated to serve the UE on the downlink and/or uplink. A finely dashed line with double arrows indicates interfering transmissions between a UE and a BS. A coarsely dashed line with double arrows indicates single frequency network (SFN) transmissions.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a resource block (RB)) may be 12 subcarriers (or 180 kHz). Consequently, the nominal FFT size may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz (i.e., 6 RBs), and there may be 1, 2, 4, 8 or 16 subbands for system bandwidth of 1.25, 2.5, 5, 10 or 20 MHz, respectively.

While aspects of the examples described herein may be associated with LTE technologies, aspects of the present disclosure may be applicable with other wireless communications systems, such as NR.

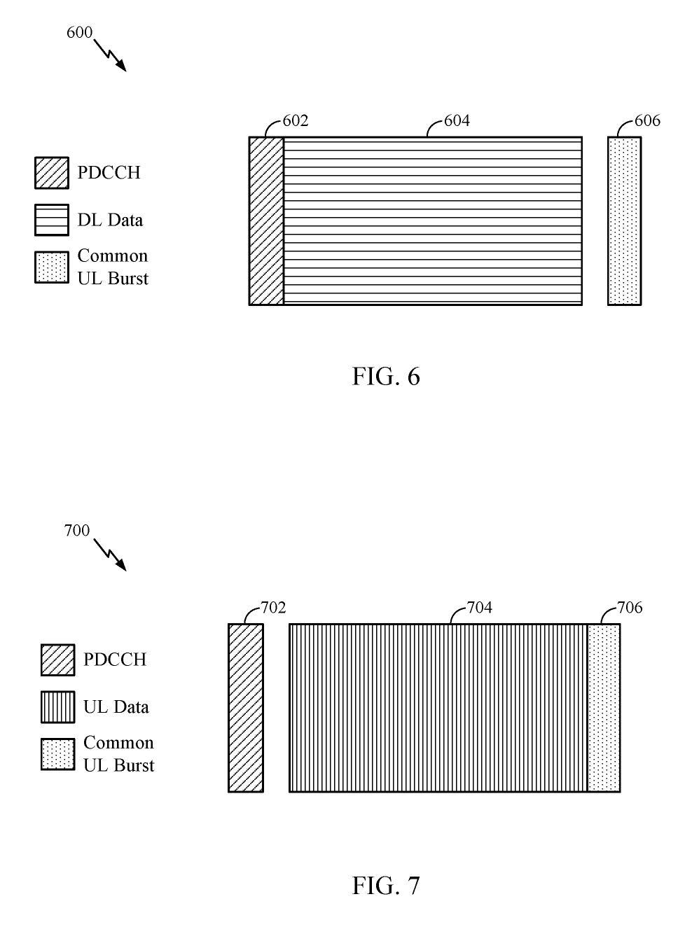

NR may utilize OFDM with a CP on the uplink and downlink and include support for half-duplex operation using TDD. A single component carrier bandwidth of 100 MHz may be supported. NR resource blocks may span 12 sub-carriers with a sub-carrier bandwidth of 75 kHz over a 0.1 ms duration. Each radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL control data. UL and DL subframes for NR may be as described in more detail below with respect to FIGS. 6 and 7. Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells. Alternatively, NR may support a different air interface, other than an OFDM-based. NR networks may include entities such CUs and/or DUs.

In some examples, access to the air interface may be scheduled, wherein a scheduling entity (e.g., a base station) allocates resources for communication among some or all devices and equipment within its service area or cell. Within the present disclosure, as discussed further below, the scheduling entity may be responsible for scheduling, assigning, reconfiguring, and releasing resources for one or more subordinate entities. That is, for scheduled communication, subordinate entities utilize resources allocated by the scheduling entity. BSs are not the only entities that may function as a scheduling entity. That is, in some examples, a UE may function as a scheduling entity, scheduling resources for one or more subordinate entities (e.g., one or more other UEs). In this example, the UE is functioning as a scheduling entity, and other UEs utilize resources scheduled by the UE for wireless communication. A UE may function as a scheduling entity in a peer-to-peer (P2P) network, and/or in a mesh network. In a mesh network example, UEs may communicate directly with one another in addition to communicating with the scheduling entity.

Thus, in a wireless communication network with a scheduled access to time-frequency resources and having a cellular configuration, a P2P configuration, and a mesh configuration, a scheduling entity and one or more subordinate entities may communicate utilizing the scheduled resources.

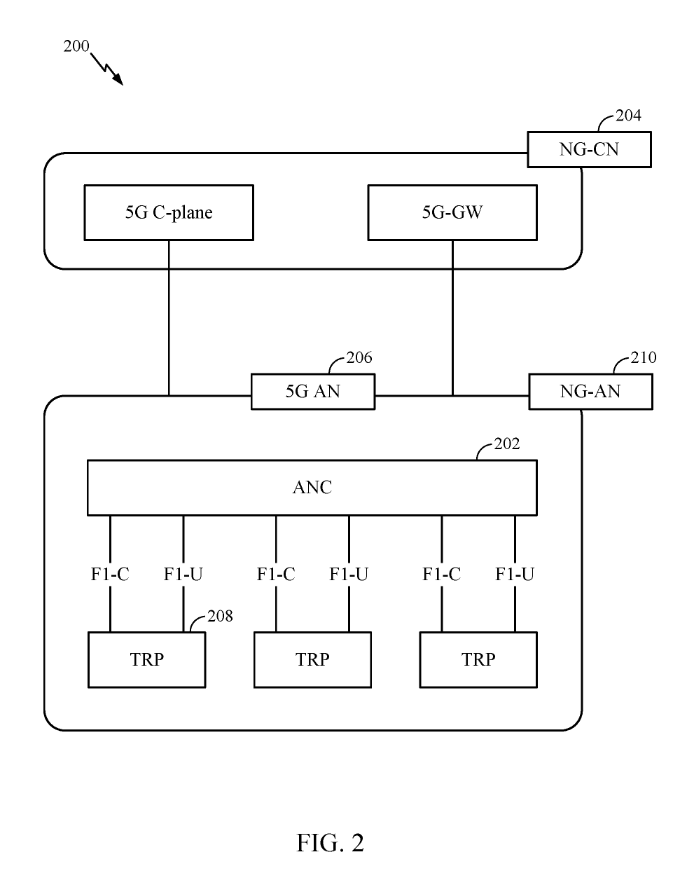

FIG. 2 illustrates an example logical architecture of a distributed radio access network (RAN) 200, which may be implemented in the wireless communication system illustrated in FIG. 1. A 5G access node 206 may include an access node controller (ANC) 202. The ANC 202 may be a central unit (CU) of the distributed RAN 200. The backhaul interface to the next generation core network (NG-CN) 204 may terminate at the ANC 202. The backhaul interface to neighboring next generation access nodes (NG-ANs) 210 may terminate at the ANC 202. The ANC 202 may include one or more TRPs 208 (which may also be referred to as BSs, NR BSs, Node Bs, 5G NBs, APs, or some other term). As described above, a TRP may be used interchangeably with “cell.”

The TRPs 208 may be a DU. The TRPs may be connected to one ANC (e.g., ANC 202) or more than one ANC (not illustrated). For example, for RAN sharing, radio as a service (RaaS), and service specific AND deployments, the TRP may be connected to more than one ANC. A TRP may include one or more antenna ports. The TRPs may be configured to individually (e.g., dynamic selection) or jointly (e.g., joint transmission) serve traffic to a UE. The TRPs 208 may send identical signals simultaneously on a same frequency, such as paging messages and/or keep alive (KA) signals, as single frequency network (SFN) transmissions to a UE. The TRPs 208 may be in a same tracking area (TA) or zone.

The logical architecture 200 may be used to illustrate fronthaul definition. The logical architecture 200 may support fronthauling solutions across different deployment types. For example, the logical architecture 200 may be based on transmit network capabilities (e.g., bandwidth, latency, and/or jitter).

The v may share features and/or components with LTE. NG-AN 210 may support dual connectivity with NR. The NG-AN 210 may share a common fronthaul for LTE and NR.

The architecture may enable cooperation between and among TRPs 208. For example, cooperation may be preset within a TRP and/or across TRPs via the ANC 202. There may be no inter-TRP interface.

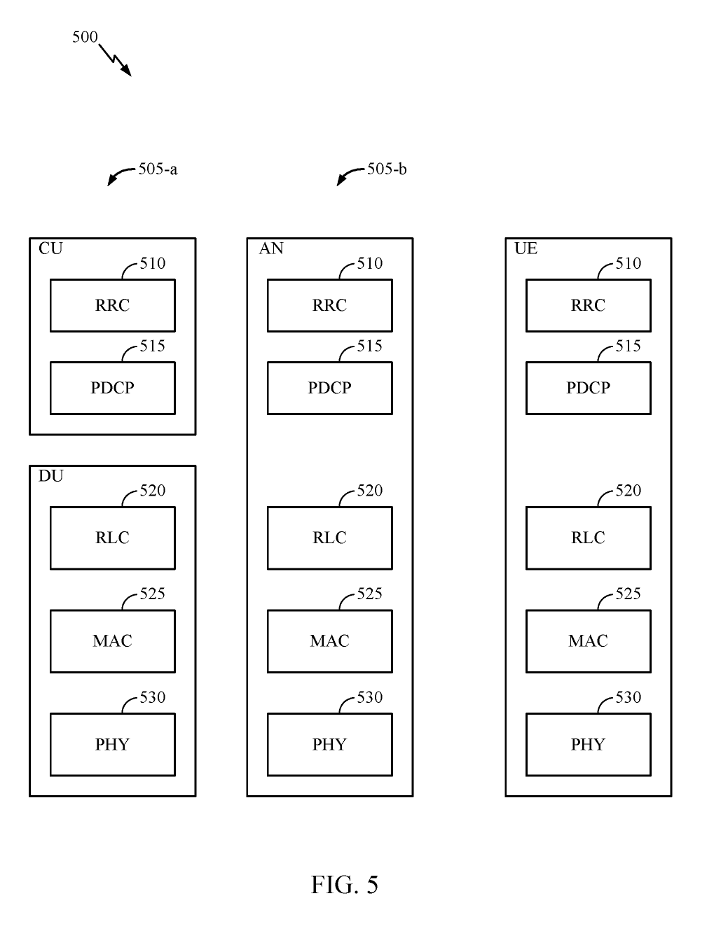

Logical architecture 200 may support a dynamic configuration of split logical functions. As will be described in more detail with reference to FIG. 5, the Radio Resource Control (RRC) layer, Packet Data Convergence Protocol (PDCP) layer, Radio Link Control (RLC) layer, Medium Access Control (MAC) layer, and a Physical (PHY) layers may be adaptably placed at the DU or CU (e.g., TRP or ANC, respectively). A BS may include a central unit (CU) (e.g., ANC 202) and/or one or more distributed units (e.g., one or more TRPs 208).

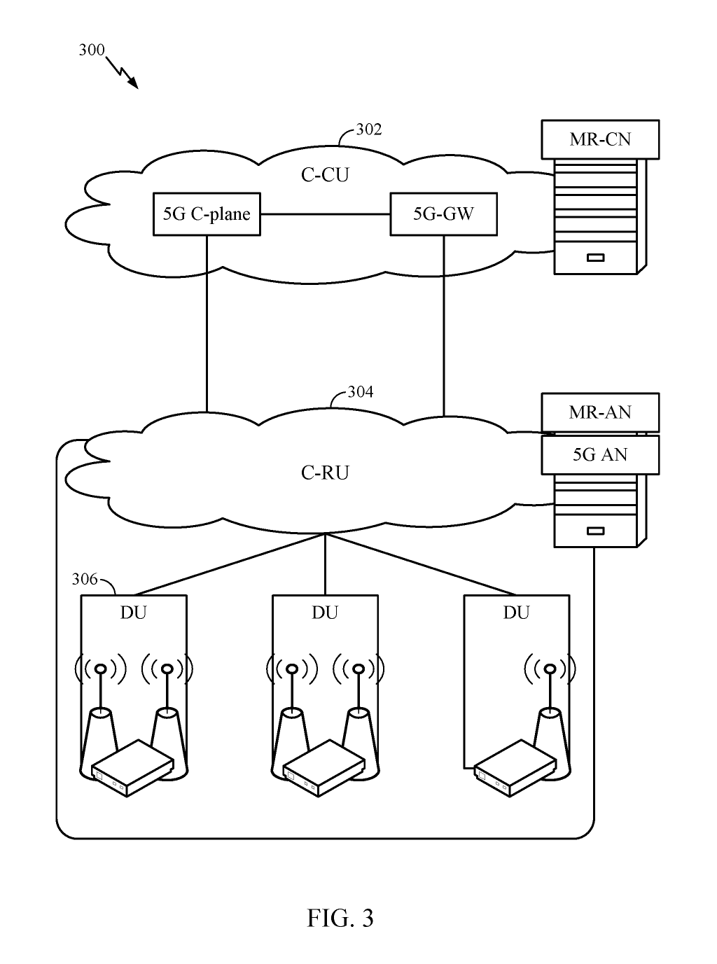

FIG. 3 illustrates an example physical architecture 300 of a distributed RAN, according to aspects of the present disclosure. A centralized core network unit (C-CU) 302 may host core network functions. The C-CU 302 may be centrally deployed. C-CU functionality may be offloaded (e.g., to advanced wireless services (AWS)), in an effort to handle peak capacity. A centralized RAN unit (C-RU) 304 may host one or more ANC functions. The C-RU 304 may host core network functions locally. The C-RU 304 may have distributed deployment. The C-RU may be closer to the network edge. A DU 306 may host one or more TRPs (edge node (EN), an edge unit (EU), a radio head (RH), a smart radio head (SRH), or the like). The DU may be located at edges of the network with radio frequency (RF) functionality.

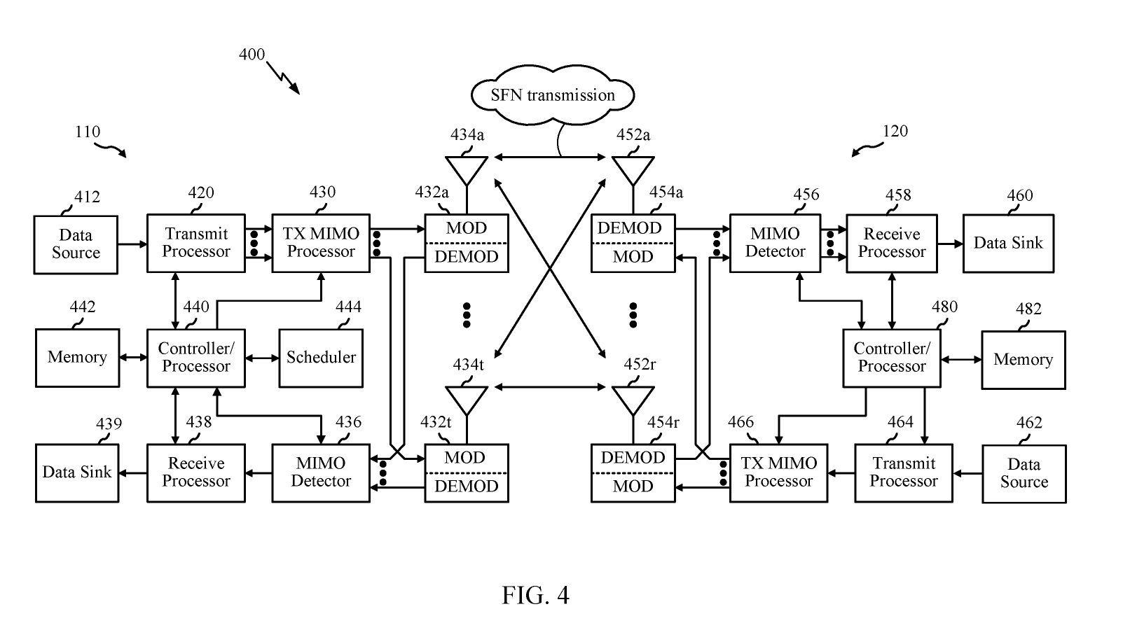

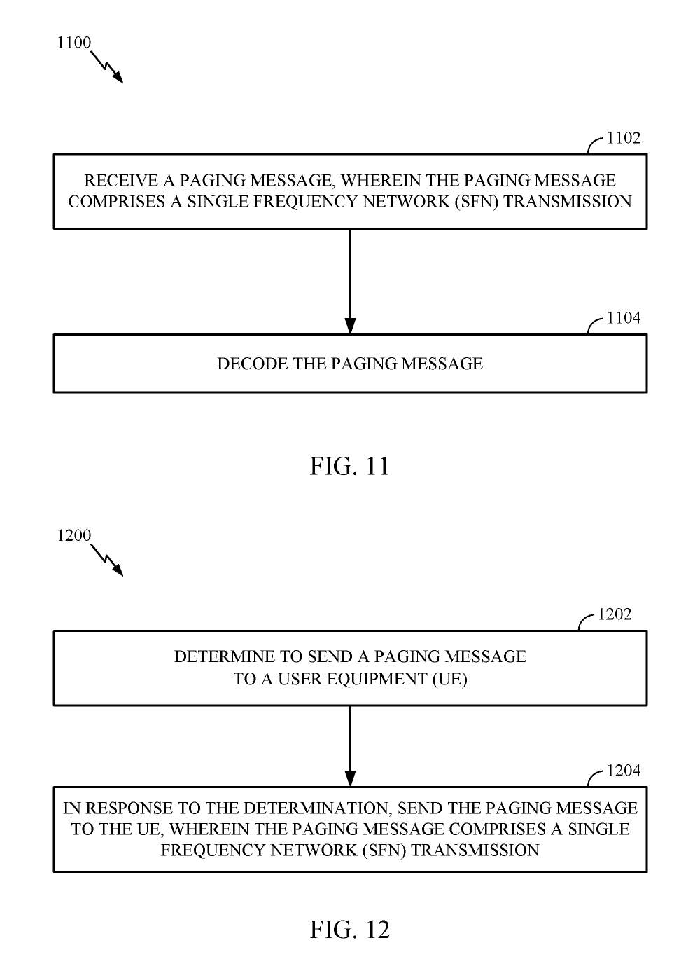

FIG. 4 illustrates example components of the BS 110 and UE 120 illustrated in FIG. 1, which may be used to implement aspects of the present disclosure. One or more components of the BS 110 and UE 120 may be used to practice aspects of the present disclosure. For example, antennas 452, Tx/Rx 222, processors 466, 458, 464, and/or controller/processor 480 of the UE 120 and/or antennas 434, processors 460, 420, 438, and/or controller/processor 440 of the BS 110 may be used to perform the operations described herein and illustrated with reference to FIGS. 11-14. According to certain aspects, the BS 110 may send a transmission, such as a paging message or KA signal, to the UE 120 as an SFN transmission.

FIG. 4 shows a block diagram of a design of a BS 110 and a UE 120, which may be one of the BSs and one of the UEs in FIG. 1. For a restricted association scenario, the BS 110 may be the macro BS 110c in FIG. 1, and the UE 120 may be the UE 120y. The BS 110 may also be a BS of some other type. The BS 110 may be equipped with antennas 434a through 434t, and the UE 120 may be equipped with antennas 452a through 452r.

At the BS 110, a transmit processor 420 may receive data from a data source 412 and control information from a controller/processor 440. The control information may be for the Physical Broadcast Channel (PBCH), Physical Control Format Indicator Channel (PCFICH), Physical Hybrid ARQ Indicator Channel (PHICH), Physical Downlink Control Channel (PDCCH), etc. The data may be for the Physical Downlink Shared Channel (PDSCH), etc. The processor 420 may process (e.g., encode and symbol map) the data and control information to obtain data symbols and control symbols, respectively. The processor 420 may also generate reference symbols, e.g., for the PSS, SSS, and cell-specific reference signal. A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) 432a through 432t. Each modulator 432 may process a respective output symbol stream (e.g., for OFDM, etc.) to obtain an output sample stream. Each modulator 432 may further process (e.g., convert to analog, amplify, filter, and upconvert) the output sample stream to obtain a downlink signal. Downlink signals from modulators 432a through 432t may be transmitted via the antennas 434a through 434t, respectively.

At the UE 120, the antennas 452a through 452r may receive the downlink signals from the BS 110 and may provide received signals to the demodulators (DEMODs) 454a through 454r, respectively. Each demodulator 454 may condition (e.g., filter, amplify, downconvert, and digitize) a respective received signal to obtain input samples. Each demodulator 454 may further process the input samples (e.g., for OFDM, etc.) to obtain received symbols. A MIMO detector 456 may obtain received symbols from all the demodulators 454a through 454r, perform MIMO detection on the received symbols if applicable, and provide detected symbols. A receive processor 458 may process (e.g., demodulate, deinterleave, and decode) the detected symbols, provide decoded data for the UE 120 to a data sink 460, and provide decoded control information to a controller/processor 480.

On the uplink, at the UE 120, a transmit processor 464 may receive and process data (e.g., for the Physical Uplink Shared Channel (PUSCH)) from a data source 462 and control information (e.g., for the Physical Uplink Control Channel (PUCCH) from the controller/processor 480. The transmit processor 464 may also generate reference symbols for a reference signal. The symbols from the transmit processor 464 may be precoded by a TX MIMO processor 466 if applicable, further processed by the demodulators 454a through 454r (e.g., for SC-FDM, etc.), and transmitted to the BS 110. At the BS 110, the uplink signals from the UE 120 may be received by the antennas 434, processed by the modulators 432, detected by a MIMO detector 436 if applicable, and further processed by a receive processor 438 to obtain decoded data and control information sent by the UE 120. The receive processor 438 may provide the decoded data to a data sink 439 and the decoded control information to the controller/processor 440.

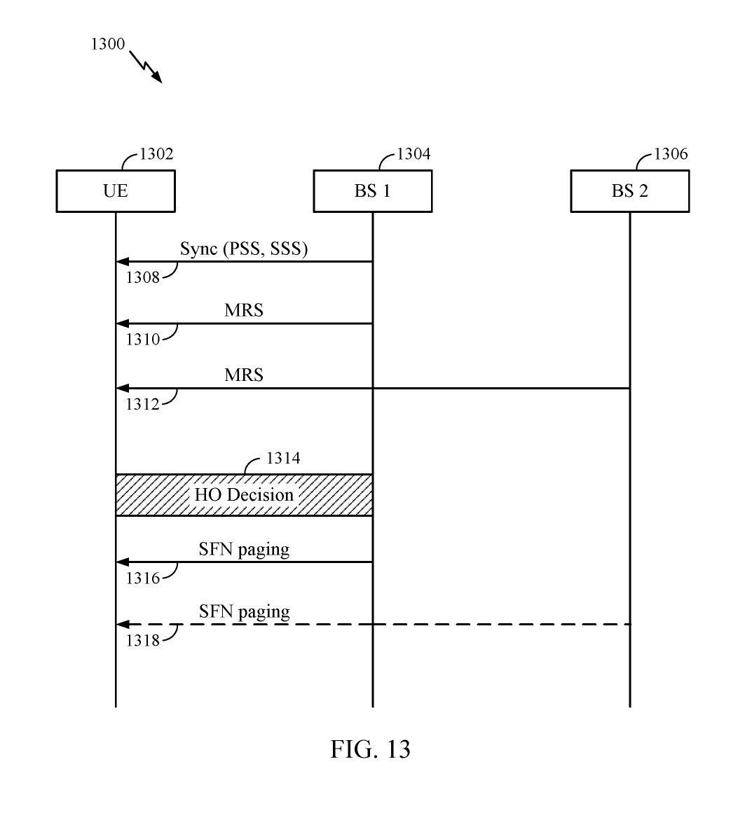

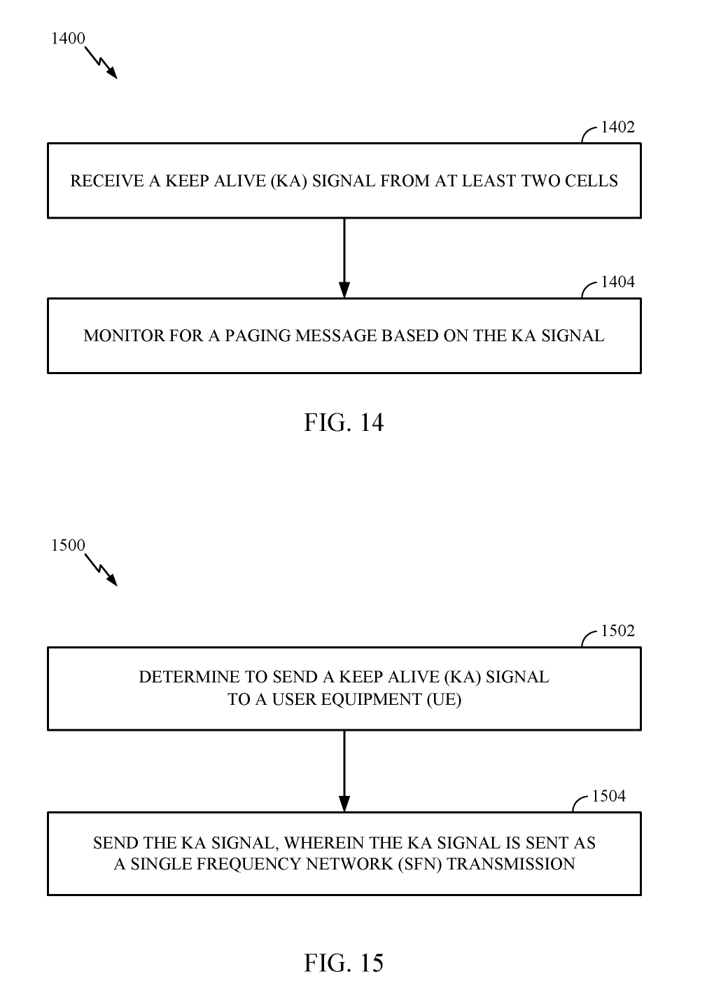

The controllers/processors 440 and 480 may direct the operation at the base station 110 and the UE 120, respectively. The processor 440 and/or other processors and modules at the BS 110 may perform or direct, e.g., the execution of various processes for the techniques described herein. The processor 480 and/or other processors and modules at the UE 120 may also perform or direct, e.g., the execution of the functional blocks illustrated in FIGS. 11 and 13, and/or other processes for the techniques described herein. The processor 440 and/or other processors and modules at the BS 110 may also perform or direct, e.g., the execution of the functional blocks illustrated in FIGS. 12 and 14, and/or other processes for the techniques described herein. The memories 442 and 482 may store data and program codes for the BS 110 and the UE 120, respectively. A scheduler 444 may schedule UEs for data transmission on the downlink and/or uplink.

FIG. 5 illustrates a diagram 500 showing examples for implementing a communications protocol stack, according to aspects of the present disclosure. The illustrated communications protocol stacks may be implemented by devices operating in a in a 5G system (e.g., a system that supports uplink-based mobility). Diagram 500 illustrates a communications protocol stack including a Radio Resource Control (RRC) layer 510, a Packet Data Convergence Protocol (PDCP) layer 515, a Radio Link Control (RLC) layer 520, a Medium Access Control (MAC) layer 525, and a Physical (PHY) layer 530. In various examples the layers of a protocol stack may be implemented as separate modules of software, portions of a processor or ASIC, portions of non-collocated devices connected by a communications link, or various combinations thereof. Collocated and non-collocated implementations may be used, for example, in a protocol stack for a network access device (e.g., ANs, CUs, and/or DUs) or a UE.

A first option 505-a shows a split implementation of a protocol stack, in which implementation of the protocol stack is split between a centralized network access device (e.g., an ANC 202 in FIG. 2) and distributed network access device (e.g., DU 208 in FIG. 2). In the first option 505-a, an RRC layer 510 and a PDCP layer 515 may be implemented by the central unit, and an RLC layer 520, a MAC layer 525, and a PHY layer 530 may be implemented by the DU. In various examples the CU and the DU may be collocated or non-collocated. The first option 505-a may be useful in a macro cell, micro cell, or pico cell deployment.

A second option 505-b shows a unified implementation of a protocol stack, in which the protocol stack is implemented in a single network access device (e.g., access node (AN), new radio base station (NR BS), a new radio Node-B (NR NB), a network node (NN), or the like.). In the second option, the RRC layer 510, the PDCP layer 515, the RLC layer 520, the MAC layer 525, and the PHY layer 530 may each be implemented by the AN. The second option 505-b may be useful in a femto cell deployment.

Regardless of whether a network access device implements part or all of a protocol stack, a UE may implement an entire protocol stack (e.g., the RRC layer 510, the PDCP layer 515, the RLC layer 520, the MAC layer 525, and the PHY layer 530).

FIG. 6 is a diagram showing an example of a DL-centric slot 600 (e.g., sometimes referred to as a subframe). The DL-centric slot 600 may include a control portion 602. The control portion 602 may exist in the initial or beginning portion of the DL-centric slot 600. The control portion 602 may include various scheduling information and/or control information corresponding to various portions of the DL-centric slot 600. In some configurations, the control portion 602 may be a physical DL control channel (PDCCH), as indicated in FIG. 6. The DL-centric slot 600 may also include a DL data portion 604. The DL data portion 604 may be referred to as the payload of the DL-centric slot 600. The DL data portion 604 may include the communication resources utilized to communicate DL data from the scheduling entity (e.g., UE or BS) to the subordinate entity (e.g., UE). In some configurations, the DL data portion 604 may be a physical DL shared channel (PDSCH).

The DL-centric slot 600 may also include a common UL portion 606. The common UL portion 606 may sometimes be referred to as an UL burst, a common UL burst, and/or various other suitable terms. The common UL portion 606 may include feedback information corresponding to various other portions of the DL-centric slot 600. For example, the common UL portion 606 may include feedback information corresponding to the control portion 602. Non-limiting examples of feedback information may include an ACK signal, a NACK signal, a HARQ indicator, and/or various other suitable types of information. The common UL portion 606 may include additional or alternative information, such as information pertaining to random access channel (RACH) procedures, scheduling requests (SRs), and various other suitable types of information. As illustrated in FIG. 6, the end of the DL data portion 604 may be separated in time from the beginning of the common UL portion 606. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 7 is a diagram showing an example of an UL-centric slot 700. The UL-centric slot 700 may include a control portion 702. The control portion 702 may exist in the initial or beginning portion of the UL-centric slot 700. The control portion 702 in FIG. 7 may be similar to the control portion 602 described above with reference to FIG. 6. The UL-centric slot 700 may also include an UL data portion 704. The UL data portion 704 may sometimes be referred to as the payload of the UL-centric slot 700. The UL portion may refer to the communication resources utilized to communicate UL data from the subordinate entity (e.g., UE) to the scheduling entity (e.g., UE or BS). In some configurations, the control portion 702 may be a PDCCH.

As illustrated in FIG. 7, the end of the control portion 702 may be separated in time from the beginning of the UL data portion 704. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot 700 may also include a common UL portion 706. The common UL portion 706 in FIG. 7 may be similar to the common UL portion 606 described above with reference to FIG. 7. The common UL portion 706 may additional or alternative include information pertaining to channel quality indicator (CQI), sounding reference signals (SRSs), and various other suitable types of information. One of ordinary skill in the art will understand that the foregoing is merely one example of an UL-centric subframe and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet-of-Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

A UE may operate in various radio resource configurations, including a configuration associated with transmitting pilots using a dedicated set of resources (e.g., a radio resource control (RRC) dedicated state, etc.) or a configuration associated with transmitting pilots using a common set of resources (e.g., an RRC common state, etc.). When operating in the RRC dedicated state, the UE may select a dedicated set of resources for transmitting a pilot signal to a network. When operating in the RRC common state, the UE may select a common set of resources for transmitting a pilot signal to the network. In either case, a pilot signal transmitted by the UE may be received by one or more network access devices, such as an AN, or a DU, or portions thereof. Each receiving network access device may be configured to receive and measure pilot signals transmitted on the common set of resources, and also receive and measure pilot signals transmitted on dedicated sets of resources allocated to the UEs for which the network access device is a member of a monitoring set of network access devices for the UE. One or more of the receiving network access devices, or a CU to which receiving network access device(s) transmit the measurements of the pilot signals, may use the measurements to identify serving cells for the UEs, or to initiate a change of serving cell for one or more of the UEs.

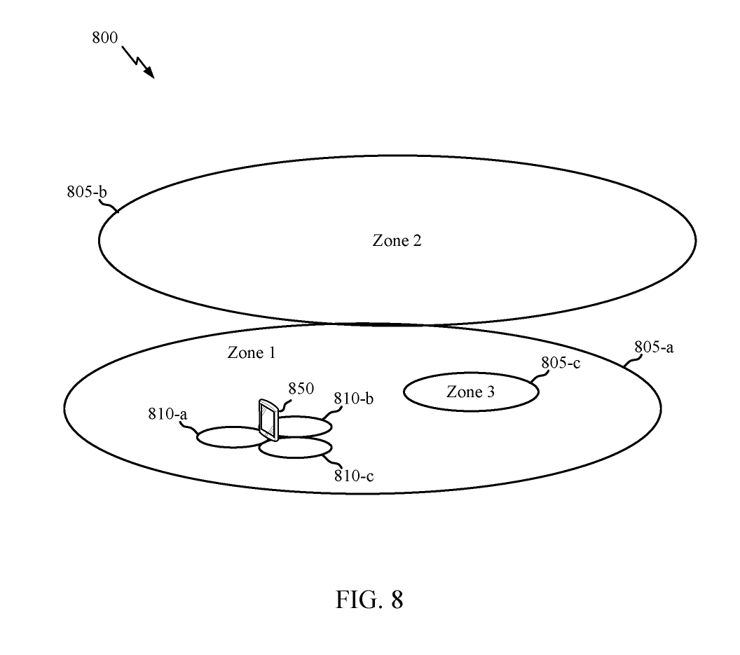

FIG. 8 illustrates an example of a wireless communication system 800 supporting a number of zones, in accordance with aspects of the present disclosure. The wireless communication system 800 may include a number of zones (including, e.g., a first zone 805-a (Zone 1), a second zone 805-b (Zone 2), and a third zone 805-c (Zone 3)). A number of UEs may move within or between the zones.

A zone may include multiple cells, and the cells within a zone may be synchronized (e.g., the cells may share the same timing). Wireless communication system 800 may include examples of both non-overlapping zones (e.g., the first zone 805-a and the second zone 805-b) and overlapping zones (e.g., the first zone 805-a and the third zone 805-c). In some examples, the first zone 805-a and the second zone 805-b may each include one or more macro cells, micro cells, or pico cells, and the third zone 1105-c may include one or more femto cells.

By way of example, the UE 850 is shown to be located in the first zone 805-a. If the UE 850 is operating with a radio resource configuration associated with transmitting pilot signals using a common set of resources, such as an RRC common state, the UE 850 may transmit a pilot signal using a common set of resources. Cells (e.g., ANs, DUs, etc.) within the first zone 805-a may monitor the common set of resources for a pilot signal from the UE 850. If the UE 850 is operating with a radio resource configuration associated with transmitting pilot signals using a dedicated set of resource, such as an RRC dedicated state, the UE 850 may transmit a pilot signal using a dedicated set of resources. Cells of a monitoring set of cells established for the UE 850 within the first zone 805-a (e.g., a first cell 810-a, a second cell 810-b, and a third cell 810-c) may monitor the dedicated set of resources for the pilot signal of the UE 850. According to certain aspects, the cells in a zone, such as cells 810-a, 810-b, and/or 801c may act as a single frequency network (SFN) and simultaneously send identical signals on a same frequency.

### Example Uplink and Downlink Based Mobility Using Single Frequency Network (SFN) Paging and/or Keep Alive Signals

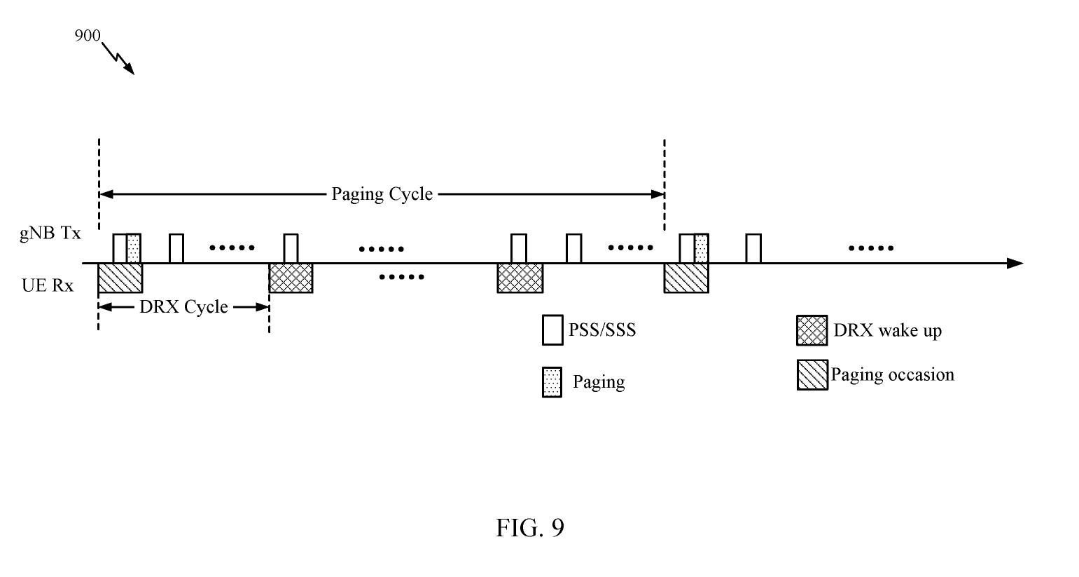

FIG. 9 is a transmission timeline 900 illustrating an example downlink-based mobility scenario for a user equipment (UE) (e.g., similar to UE 120) in discontinuous reception (DRX) operation, in accordance with certain aspects of the present disclosure. As shown in FIG. 9, in downlink-based mobility, the UE may wake up during a paging occasion (PO). The UE may synchronize to the network (e.g., a base station (BS) 110). For example, the UE may receive a primary synchronization signal (PSS), a secondary synchronization signal (SSS), and/or a measurement reference signal (MRS) from a BS to synchronize to the network.

The UE may perform a cell search. For example, the UE may receive reference signals (e.g., MRS) from the serving cell and/or one or more serving cells. If a neighbor cell becomes better than the serving cell (or an offset amount better), the UE may reselect to the neighbor cell as the serving cell. If the UE reselects to a cell outside the current tracking area (TA), then the UE registers to the new TA.

As shown in FIG. 9, if the DRX wakeup coincides with a paging occasion, the UE may decode paging. Since the network is only aware of idle-mode UEs at the TA level, the UE is paged via all cells belonging to the TA in which the UE is registered; however, each cell transmits its paging channel independently other the cells. As a result, the paging channel signal-to-interference noise ratio (SINR) may suffer from inter-cell interference.

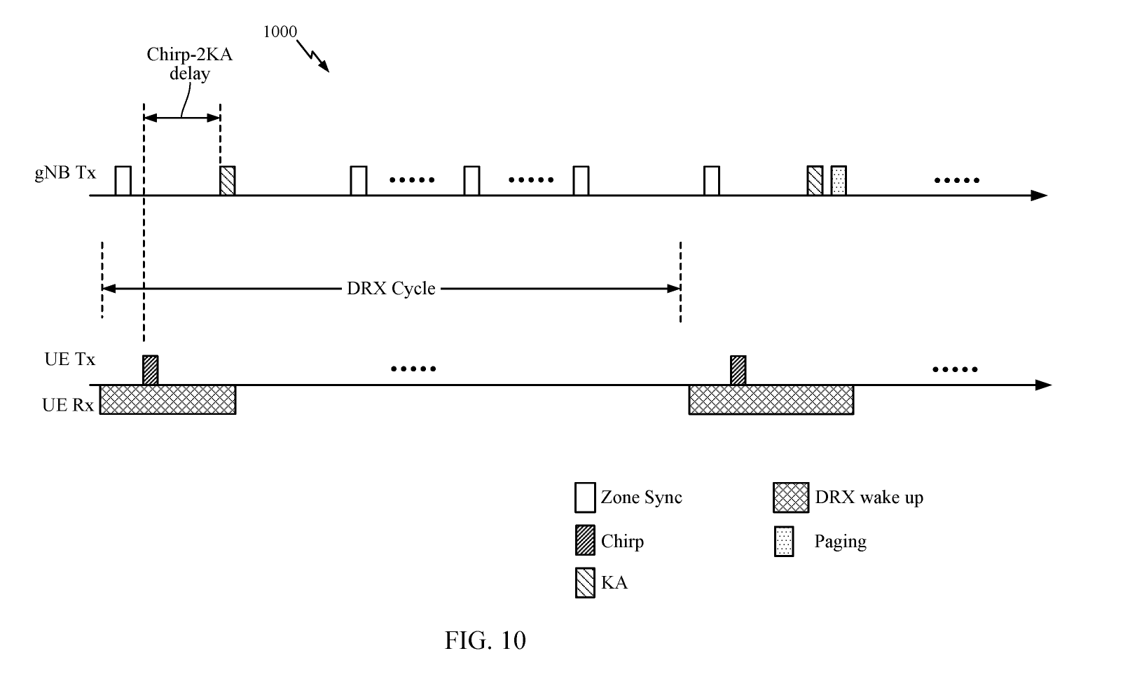

FIG. 10 is a transmission timeline 1000 illustrates uplink-based mobility scenario for a UE during DRX operation. In uplink-based mobility, a BS may make mobility decisions based on measurements of an uplink reference signal from a UE (e.g., without sending any MRS). As shown in FIG. 10, during a DRX wake up period, the UE may synchronize, for example, based on receiving the zone synchronization signal and the UE sends the UE sends uplink reference signal (e.g., chirps), for example, the physical uplink mobility indicator channel (PUMICH). Examples of zone synchronization signals include, for example, a zone PSS, zone SSS, MRS-z, etc. The UE may use the zone synchronization signal to resynchronize to the zone and/or perform measurements on the zone synchronization signals. The UE may measure the zone synchronization signal in an effort to determine if the UE is located in the zone or if the UE has moved into another zone. As described above, a zone may refer to a group of BSs managed by an ANC (e.g., a zone may include the three TRPs 708 illustrated in FIG. 7, managed by the ANC 702).

As shown in FIG. 10, the UE monitors for a keep alive (KA) signal (e.g., the physical KA channel (PKACH)) from the network. The KA signal may indicate whether there is a paging message for the UE. In response to the uplink reference signal, the network (e.g., the ANC/CU) may perform cell search and select a cell to serve the UE (e.g., without the UE being aware of the selected cell). The network selects the BS for transmitting the KA signal and paging to the UE.

In some cases, the network may not select the best cell for sending the KA signal and/or paging. This may be due to an interference profile mismatch between uplink and downlink. For example, the cell that receives the strongest uplink reference signal (e.g., PUMICH) may not be the closest cell (i.e., having lowest pathloss) to the UE. Another reason could be that the network may have out-of-date data. For example, as a result of Layer 3 filtering, the average PUMICH SINRs may not reflect the current instantaneous PUMICH SINR and result in not picking the best cell. This may result in the UE missing the KA signal which, in turn, may result in the UE missing the paging (since the paging indication is carried in the KA signal).

Aspects of the present disclosure provide techniques and apparatus for uplink and downlink based mobility using single frequency network (SFN) paging message and/or multiple KA signal transmissions in a wireless network, such as NR.

### Example SFN Paging Message Transmission

According to certain aspects, paging message misses in downlink and uplink based mobility can be reduced by transmitting the paging message as a single frequency network (SFN) transmission. For example, in downlink-based mobility, cells within a tracking area can transmit the paging message SFN and, in uplink-based mobility, cells within a zone can transmit the paging message SFN. As used herein, SFN transmission refers to simultaneous (or at approximately a same time) transmissions of an identical signal (or a signal having approximately a same waveform) on same frequency resources (or approximately the same frequency resources). Thus, the SFN transmissions may boost one another rather than interfere with one another, which may result in a higher paging SINR. The higher SINR reduces likelihood that the KA signal and, in turn, the paging message will be missed.

FIG. 11 is a flow diagram illustrating example operations 1100 that may be performed, for example, by a UE (e.g., UE 120), for receiving a paging message as a single frequency network (SFN) transmission, in accordance with certain aspects of the present disclosure. The operations 1100 may be performed, for example, by a UE (e.g., UE 120). Operations 1100 may begin at 1102 by receiving a paging message, wherein the paging message comprises a SFN transmission. The SFN transmission may be received from a plurality of cells (e.g., cells within a TA or zone) that transmit an identical paging message simultaneously on a same frequency. At 1104, the UE decodes the paging message.

FIG. 12 is a flow diagram illustrating example operations 1200 that may be performed, for example, by a BS (e.g., BS 110), for sending a paging message as a SFN transmission, in accordance with certain aspects of the present disclosure. The operations 1200 may be complementary operations to the operations 1100 performed by the UE. The operations 1200 may begin, at 1202, by determining to send a paging message to a UE (e.g., there is data for the UE). At 1202, in response to the determination, the BS sends the paging message to the UE, wherein the paging message comprises a SFN transmission. The SFN transmission may be sent from a plurality of cells (e.g., within a TA or zone), including the BS, that transmit an identical paging message simultaneously on a same frequency.

FIG. 13 is a call flow diagram 1300 illustrating example signaling for paging messages as SFN transmissions for downlink based mobility, in accordance with certain aspects of the present disclosure. As shown in FIG. 13, at 1308, the UE 1302 receives synchronization signals from the BS 1304. At 1310 and 1312, the UE 1302 can receive measurement reference signals from the BS1 1304 and BS2 1306. The UE 1302 can make a handover decision (e.g., cell reselection) based on the measurements at 1314. At 1316 and 1318, the UE 1502 can receive an SFN paging message transmission from the BS1 1304 and BS2 1306. The BS1 1304 and BS2 1306 may be cells within a tracking area.

### Example KA Signal Transmission from Multiple Cells

According to certain aspects, KA signal (e.g., PKACH) misses in uplink based mobility can be reduced by transmitting the KA from multiple cells which may increase the probability that KA is transmitted from the best cell—or from a better cell than the currently selected cell. In aspects, the KA signal can be transmitted as a SFN transmission from the multiple cells, which increase the SINR of the KA signal. Reducing the KA signal misses may also reduce paging misses since the KA may carry the paging indicator.

FIG. 14 is a flow diagram illustrating example operations 1400 that may be performed, for example, by a UE (e.g., UE 120), for receiving a KA signal from multiple BSs, in accordance with certain aspects of the present disclosure. The operations 1400 may begin, at 1402, by transmitting an uplink reference signal (e.g., chirp or PUMICH) to one or more of a plurality of cells. At 1404, the UE receives a KA signal (e.g., PKACH) from at least two of the plurality of cells (e.g., within a zone). At 1406, the UE monitors for a paging message based on the KA signal. In aspects, the KA signal is received as a single frequency network (SFN) transmission. The SFN transmission may be received from the at least two cells that transmit an identical KA signal simultaneously on a same frequency.

FIG. 15 is a flow diagram illustrating example operations 1500 that may be performed, for example, by a BS, for sending a KA signal as a SFN transmission, in accordance with certain aspects of the present disclosure. Although not shown, optionally, the operations 1500 may begin by receiving an uplink reference signal (e.g., a chirp or PUMICH) from a UE. At 1502, the BS determines to send a KA signal. At 1504, the BS sends the KA signal, wherein the KA signal is sent as a SFN transmission. The SFN transmission may sent from at least two cells (e.g., within a zone), including the BS, that transmit an identical KA signal simultaneously on a same frequency.

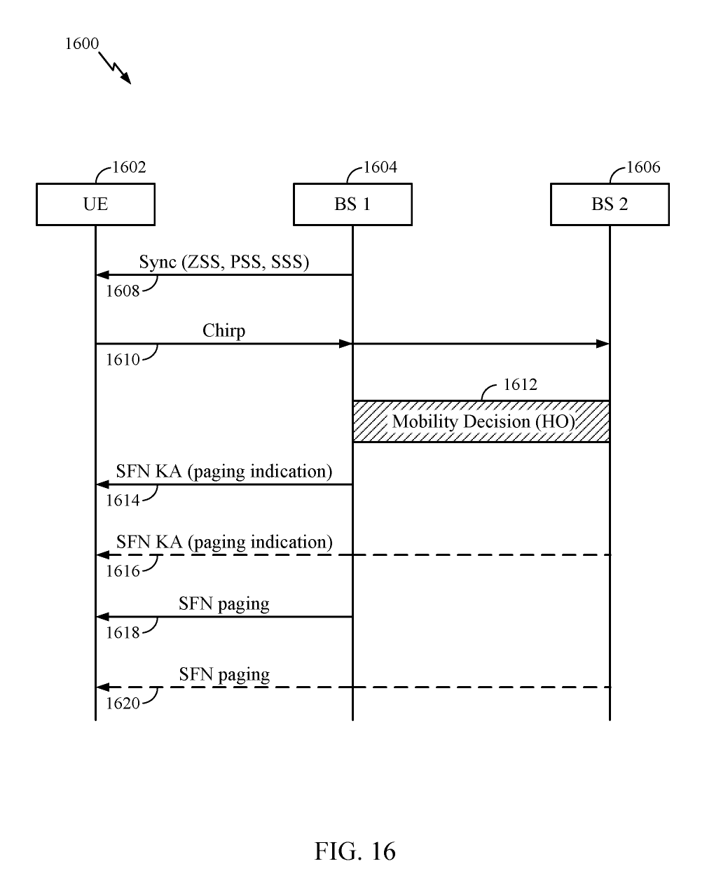

FIG. 16 is a call flow diagram 1600 illustrating example signaling for paging messages and/or KA signals as SFN transmissions for uplink based mobility, in accordance with certain aspects of the present disclosure. As shown in FIG. 16, at 1608, the UE 1602 may receive synchronization (e.g., PSS, SSS, and/or ZSS) from the BS1 1604. At 1610, the UE 1602 can send an uplink reference signal (e.g., chirp or PUMICH). At 1612, the network makes a mobility decision (e.g., a handover decision) based on the uplink reference signal. At 1614 and 1616, the UE 1602 may receive a KA signal (e.g., PKACH) from the BS1 1604 and BS2 1606. In addition, at 1618 and 1620, the UE 1602 may receive paging SFN from the BS1 1604 and BS2 1606. In aspects, the BS1 1604 and BS2 1606 are cells within a zone.

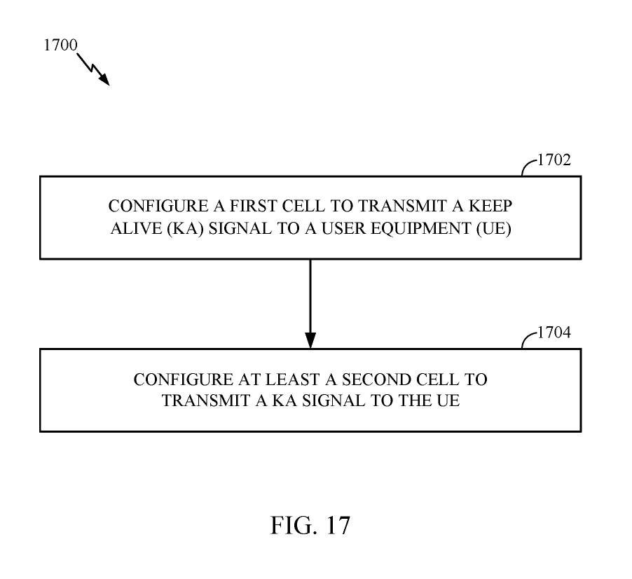

FIG. 17 is a flow diagram illustrating example operations 1700 that may be performed, for example, by a network (e.g., a CU such as ANC 202), for configuring multiple cells to transmit a KA signal (and/or a paging message) to a UE, in accordance with certain aspects of the present disclosure. The operations 1700 may begin, at 1702, by configuring a first cell to transmit a KA signal (and/or paging message) to a UE. At 1704, the network entity configures a second cell to transmit a KA signal (and/or paging message) to the UE. The first and second cells may be cells within a same tracking area or zone. The network entity may configure the first and second cells to transmit the KA signal (and/or paging message) as an SFN transmission.

In aspects, using SFN transmission for paging and/or multiple cell transmission of KA signals may help to reduce the miss rate of pages in uplink and downlink mobility.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communications by a user equipment (UE), comprising:
receiving a paging message, wherein the paging message comprises a single frequency network (SFN) transmission; and
decoding the paging message.

2. The method of claim 1, wherein the SFN transmission comprises a transmission received from a plurality of cells that transmit an identical paging message simultaneously on a same frequency.

3. The method of claim 2, further comprising:
registering to a tracking area (TA), wherein the plurality of cells comprises cells within the TA.

4. The method of claim 2, further comprising:
measuring reference signals from one or more of the plurality of cells; and
selecting a serving cell based on the measurements.

5. The method of claim 2, further comprising:
entering a wake period from a discontinuous receive (DRX) low power mode of a DRX cycle; and
receiving the paging message during the wake period.

6. The method of claim 2, wherein the plurality of cells comprises synchronized cells within a zone.

7. The method of claim 6, further comprising:
transmitting an uplink reference signal to one or more of the plurality of cells;
receiving at least one keep alive (KA) signal from at least one of the plurality of cells; and
monitoring for the paging message based on the KA signal.

8. A method for wireless communications by a user equipment (UE), comprising:
transmitting an uplink reference signal to one or more of a plurality of cells;
receiving a keep alive (KA) signal from at least two of the plurality of cells; and
monitoring for a paging message based on the KA signal.

9. The method of claim 8, wherein the KA signal is received as a single frequency network (SFN) transmission from the at least two cells that transmit an identical KA signal simultaneously on a same frequency.

10. The method of claim 8, wherein the plurality of cells comprises synchronized cells within a zone.

11. A method for wireless communications by a base station (BS), comprising:
determining to send a paging message to a user equipment (UE); and
in response to the determination, sending a paging message to the UE, wherein the paging message comprises a single frequency network (SFN) transmission.

12. The method of claim 11, wherein the SFN transmission comprises a transmission from a plurality of cells, including the BS, that transmit an identical paging message simultaneously on a same frequency.

13. The method of claim 12, wherein the plurality of cells comprises synchronized cells within a zone.

14. The method of claim 13, further comprising:
receiving an uplink reference signal from the UE; and
making a mobility decision for the UE based on the uplink reference signal.

15. The method of claim 11, further comprising:
transmitting at least one keep alive (KA) signal to the UE, wherein the KA signal includes an indication that there is a paging message for the UE.

16. The method of claim 12, wherein the plurality of cells comprises cells within a tracking area (TA).

17. The method of claim 11, further comprising:
transmitting reference signals to the UE.

18. The method of claim 11, further comprising:
determining a paging cycle; and
sending the paging message during a paging occasion of the paging cycle.

19. A method for wireless communications by a base station (BS), comprising:
determining to send a keep alive (KA) signal to a user equipment (UE); and
sending the KA signal to the UE, wherein the KA signal is sent as a single frequency network (SFN) transmission.

20. The method of claim 19, wherein the SFN transmission comprises a transmission from at least two cells, including the BS, that transmit an identical KA signal simultaneously on a same frequency.

21. The method of claim 20, wherein the at least two cells comprise synchronized cells within a zone.

22. The method of claim 19, wherein determining to send a KA signal is based on a configuration of the BS by a network entity.
